(19) United States
(12) Patent Application Publication
(10) Pub. No.: US 2002/0046440 A1
(43) Pub. Date: Apr. 25, 2002

(54) Vehicle door handle

(76) Inventors: Astorre Agostini, Alpignano (IT); Ambrogio Martino, Lanzo Torinese (IT)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/791,485

(22) Filed: Feb. 22, 2001

(30) Foreign Application Priority Data
Feb. 23, 2000 (IT) TO2000A 000175

(51) Int. Cl. E05B 1/00

(52) U.S. Cl. 16/110.1

(57) ABSTRACT

A handle for a vehicle door has a frame fittable to the door; a manual control lever connected to the frame and having a control portion connectable mechanically to a lock on the door; and an electric control assembly for activating a security function of the lock; the control assembly having a switch, a lever transmission interposed between the control portion and the switch, and a flexible positioning device for keeping the lever and the relative control portion in an intermediate rest position between an extracted release position, wherein the control portion releases the lock, and a forward switching position, wherein the control portion is pushed towards the frame to switch the switch.

The present invention relates to a vehicle door handle.

### BACKGROUND OF THE INVENTION

Vehicle doors in general, and motor vehicle doors in particular, are opened by means of a handle, wherein an elongated frame is fitted inside the door and supports a control lever, which has a control end portion connected, in use, to the relative lock, and an opposite end portion connected to the frame by a hinge having a normally vertical axis of rotation, so as to rotate about the hinge axis between a withdrawn rest position and an extracted position releasing the lock.

More and more modern vehicles are equipped with electronic devices for remote controlling each door lock and, in particular, activating or deactivating the security function of the lock without using the key. For example, a transmitter or so-called ‘badge’ is used, which is carried by the user of the vehicle and provides for transmitting signals to a central control unit on the vehicle, which, on receiving and recognizing the signals, deactivates the security function of the lock.

The same transmitter can also be used to activate the security function of the lock. That is, when the transmitter is a given distance from the vehicle, the central control unit is no longer able to receive the signals emitted by the transmitter, and can be programmed to automatically activate the security function of the lock in the absence of a signal.

Though reliable, the above electronic device has the drawback that, in most cases, the user of the vehicle wishes to activate the security function of the lock immediately, without waiting for it to be done automatically when the transmitter is a given distance from the vehicle.

To enable the security function of the lock to be activated and checked immediately, a handle is used comprising a switch located inside the frame, just beneath the end portion of the lever hinged to the frame, so that the switching member of the switch is movable directly by the end portion of the lever. For this purpose, the hinge interposed between the frame and the end portion of the lever is so formed as to permit not only rotation but also radial displacement of the end portion inwards of the door from the rest position to a switching position, so as to trip the switch and so activate the security function of the lock.

The above handle has several drawbacks. In particular, the switch is easily damaged and subject to malfunctioning, on account of said displacement inwards of the door necessarily requiring, between the frame and the end of the lever in the rest position, a certain amount of clearance by which the switch communicates directly with the outside environment, especially in the event the complex seal provided is not positioned correctly or is damaged, e.g. by normal operation of the lever. Moreover, the lever is maintained in the rest position by a thrust spring acting directly on the lever itself, and which is often stressed even when releasing the lock, and the efficiency and reliability of which is gradually impaired by external agents, so that very often the security function of the lock remains permanently activated. Finally, the handle itself is complex in design, on account of the particular hinge and seal used, as well as the presence of elastic thrust elements, so that, in the event of a fault on the switch and/or spring, replacing the switch or spring is a particularly awkward, relatively time-consuming and, hence, expensive job.

### SUMMARY OF THE INVENTION

It is an object of the present invention to provide a handle featuring a device for activating the security function of the relative lock, but which provides for eliminating the aforementioned drawbacks and is cheap and easy to produce.

According to the present invention, there is provided a handle for a vehicle door, the handle comprising a frame fittable to said door; a manual control lever hinged to said frame and comprising a control portion, which engages in sliding manner a passage, formed in the frame, for mechanical connection to a lock on said door; and electric control means for electrically controlling said lock to activate a security function of the lock; the electric control means comprising a switch, and push-button activating means for activating said switch; characterized in that said switch is located to the side of said passage; and said push-button activating means comprise said control portion, and transmission means interposed between said control portion and said switch; flexible positioning means being provided to keep said control portion in an intermediate rest position between an extracted position releasing the lock and a forward position switching said switch.

### BRIEF DESCRIPTION OF THE DRAWINGS

A non-limiting embodiment of the invention will be described by way of example with reference to the accompanying drawings, in which:

FIG. 1 shows a section, with parts removed for clarity, of a preferred embodiment of the handle according to the present invention;

FIG. 2 shows a view in perspective, with parts removed for clarity, of a portion of the FIG. 1 handle;

FIG. 3 shows a view in perspective of a detail in FIG. 1.

### DETAILED DESCRIPTION OF THE INVENTION

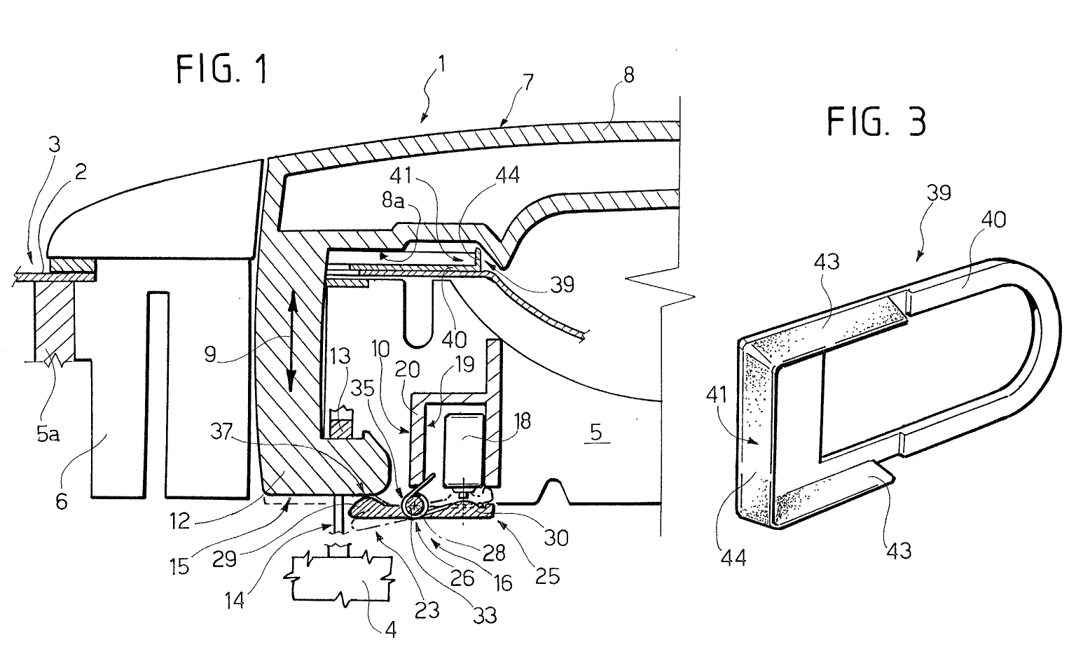

Number 1 in FIG. 1 indicates as a whole a handle connectable to a body 2 of a door 3 (shown partly) of a vehicle (not shown) to control a lock 4 on door 3.

Handle 1 comprises a frame 5 fittable inside door 3; a body 6 for supporting a key assembly (not shown) and connected in known manner to an end portion 5a of frame 5; and a substantially L-shaped lever 7, which is gripped by the user of the vehicle. More specifically, lever 7 comprises an elongated portion or grip 8 having an end portion (not shown) hinged to an end portion of frame 5, longitudinally opposite portion 5a, so as to rotate, with respect to frame 5, about a hinge axis (not shown); and an elongated control portion 9 integral with a portion of portion 8 adjacent to body 6. Control portion 9 extends through frame 5 in a direction substantially perpendicular to portion 8, loosely engages a passage 10 formed through frame 5, and terminates at the free end with a pin 12. Pin 12 projects facing portion 8, and is fitted with a known lever 13 connected to lock 4 by a Bowden cable 14, which, together with levers 7 and 13, defines as assembly 15 for mechanically activating lock 4.

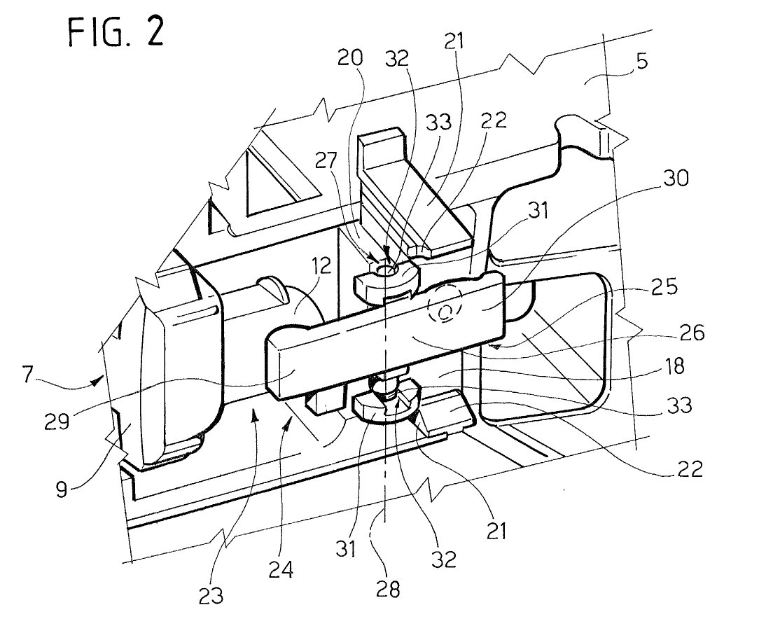

With reference to FIG. 1, handle 1 also comprises an electric control assembly 16 for activating the security function of lock 4. Assembly 16 comprises a known push-button switch 18 located to the side of passage 10 and housed inside a cavity 19 in frame 5, an inner wall 20 of which cavity defines passage 10 and extends partly facing pin 12. In the example shown, switch 18 is connected releasably to frame 5 by two elastic appendixes 21 terminating with respective retaining teeth 22 which click on to switch 18 (FIG. 2). Switch 18 is also connected electrically in known manner to a central control unit (not shown) for controlling activation of the security function of the lock, and is controlled by a push-button activating device 23 user-operated manually from the outside and forming part of assembly 16.

Device 23, of which control portion 9 forms part, comprises a lever transmission 24 interposed between control portion 9 and switch 18. In the example shown, transmission 24 comprises a single rocker arm lever 25, which extends astride wall 20, is substantially parallel to pin 12, and has an intermediate portion 26 adjacent to wall 20 and hinged to frame 5 by a hinge 27 to swing about a hinge axis 28 perpendicular to pin 12 and parallel to the hinge axis (not shown) of lever 7. Rocker arm lever 25 also comprises two opposite end portions 29 and 30, portion 29 extending facing a free end portion of pin 12, and portion 30 extending facing the movable member of switch 18. With reference to FIG. 2, hinge 27 comprises a fork, the arms 31 of which, integral with frame 5, define respective cylindrical seats 32 coaxial with axis 28 and engaged in rotary manner by respective opposite hinge pins 33 integral with intermediate portion 26 and which click inside seats 32. Each of pins 33 is wound with a respective intermediate portion of a known wire torsion spring 35 having two opposite end portions resting one on frame 5 and the other on an inner surface of end portion 30 to keep end portion 30 detached from switch 18, as shown in FIG. 1, and to force a supporting surface 37 of portion 29 against pin 12 to keep lever 7, and hence control portion 9, in an intermediate rest position (FIG. 1) between an extracted position controlling lock 4—wherein control portion 9 extends partly outside passage 10 and releases lock 4—and a forward position activating the security function of lock 4—wherein portion 9 is pushed towards frame 5 and rocker arm lever 25 is rotated as shown by the dash and dot line in FIG. 1.

With reference to FIG. 1, and particularly FIG. 3, in addition to lever 25, lever 7 is also maintained in the intermediate rest position by a flexible member 39, which is located parallel to the lever 25-spring 35 assembly, is connected to lever 7, and comprises a rigid contoured supporting portion 40 resting on an outer surface of body 2, and a collar portion 41, which is made of flexible, e.g. elastomeric, material, is integral with supporting portion 40, and extends towards and contacts the inner surface 8a of portion 8 of lever 7. More specifically, collar portion 41 comprises two flat longitudinal walls 43 facing and parallel to each other; and a flat transverse wall 44 extending facing control portion 9 and connecting longitudinal walls 43 to each other.

In actual use, as of the condition shown in FIG. 1, wherein lever 7 is in the rest position, so that portion 30 of rocker arm lever 25 is detached from the switching member of switch 18, portion 8 may be gripped to move lever 7 into the extracted position and release lock 4, or to push control portion 9 inwards of door 3, in opposition to the elastic resistance of spring 35 and portion 41 of member 39, and, by means of control portion 9, rotate lever 25 in the opposite direction into the withdrawn position activating the security function of the lock and wherein portion 30 of rocker arm lever 25 trips switch 18.

As will be clear from the foregoing description, handle 1 is, first of all, extremely straightforward in design, by lever 7 being simply hinged to frame 5 to rotate about a fixed hinge axis, and being of the same design as levers normally used in known handles.

Moreover, switch 18 is fitted to frame 5 in a position in which it can be reached and removed easily from inside the door, and is controlled by a straightforward lever transmission activated directly by control portion 9 and which provides for both switching switch 18 and keeping lever 7 in the intermediate rest position. Besides simplifying and improving the reliability of handle 1, using a straightforward lever transmission enables switch 18 to be located to the side of and at a distance from passage 10 of control portion 9, and in particular inside a cavity 19 open inwards of the door, so that any external agents infiltrating passage 10 have no effect whatsoever on switch 18, the reliability and efficiency of which therefore remains unchanged over time.

The reliability and efficiency of handle 1, and in particular of push-button activating device 23, is further enhanced by lever 7 being maintained in the intermediate rest position by both the mechanical transmission and the elastomeric member, which are located parallel to cooperate synergically, and are so formed as to adapt to each other with no manual adjustment required. The particular design of member 39 also enables it to act, not only as an elastically deformable member to keep lever 7 in the intermediate rest position, but also as a sealing member, by portion 41 of member 39 always being forced against lever 7 in the intermediate rest position or the withdrawn security function activating position.

Clearly, changes may be made to handle 1 as described herein without, however, departing from the scope of the present invention. In particular, switch 18 may be located otherwise than as shown, providing it is some distance from passage 10; rocker arm lever 25 may be replaced with a different mechanical transmission, providing it is activated by pushing the portion of lever 7 adjacent to supporting body 6 inwards of the door; and, finally, provision may be made, between lever 7 and the door body, for a retaining and sealing member other than the one described and even performing only one of the functions performed by member 39.

1) A handle (1) for a vehicle door (3), the handle (1) comprising a frame (5) fittable to said door (3); a manual control lever (7) hinged to said frame (5) and comprising a control portion (9), which engages in sliding manner a passage (10), formed in the frame (5), for mechanical connection to a lock (4) on said door (3); and electric control means (16) for electrically controlling said lock (4) to activate a security function of the lock (4); the electric control means (16) comprising a switch (18), and push-button activating means (23) for activating said switch (18); characterized in that said switch (18) is located to the side of said passage (10); and said push-button activating means (23) comprise said control portion (9), and transmission means (24) interposed between said control portion (9) and said switch (18); flexible positioning means (39)(25, 35) being provided to keep said control portion (9) in an intermediate rest position between an extracted position releasing the lock (4) and a forward position switching said switch (18).

2) A handle as claimed in claim 1, characterized in that said transmission means (24) comprise a lever transmission.

3) A handle as claimed in claim 2, characterized in that said lever transmission comprises a single rocker arm lever (25).

4) A handle as claimed in claim 3, characterized in that said rocker arm lever (25) comprises an intermediate portion (26) hinged to the frame (5) to rotate about a hinge axis (28) substantially perpendicular to said control portion (9); and two opposite end portions (29)(30) cooperating in contact with said control portion (9) and with a movable switching member for switching said switch (18).

5) A handle as claimed in claim 4, characterized in that said lever transmission (24) also comprises elastic means (35) interposed between said rocker arm lever (25) and said frame (5) to keep the rocker arm lever (25) in a reference position wherein the rocker arm lever is detached from said switch (18) and contacts said control portion (9).

6) A handle as claimed in claim 5, characterized in that said elastic means comprise a torsion spring (35) having a portion wound about said hinge axis (28).

7) A handle as claimed in claim 1, characterized in that said flexible positioning means (25, 35) comprise a supporting surface (37) for supporting said control portion (9); said supporting surface (37) extending facing a free end portion of said control portion (9) sliding inside said passage (10).

8) A handle as claimed in claim 7, characterized in that said supporting surface (37) laterally defines a movable member (25) of said transmission means (24).

9) A handle as claimed in claim 7, characterized in that said flexible positioning means (25, 35) also comprise elastic thrust means (35) for pushing said supporting surface (37) towards said control portion (9).

10) A handle as claimed in claim 1, characterized in that said flexible positioning means (39) also comprise a positioning member in turn comprising a supporting portion (40) positioned, in use, contacting said door (3), and a collar portion (41) of elastomeric material at least partly surrounding said control portion (9) and connected integrally to the supporting portion (40).
